(19) United States
(12) Patent Application Publication
(10) Pub. No.: US 2006/0007207 A1
(43) Pub. Date: Jan. 12, 2006

(54) Liquid crystal display device and method of driving liquid crystal display device

(75) Inventor: Seiji Kawaguchi, Osaka (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Toshiba Matsushita Display Technology Co., Ltd., Tokyo (JP)

(21) Appl. No.: 11/094,214

(22) Filed: Mar. 31, 2005

(30) Foreign Application Priority Data
Apr. 1, 2004 (JP) 2004-109286

(51) Int. Cl. G09G 5/00

(52) U.S. Cl. 345/204

(57) ABSTRACT

A liquid crystal display device includes a liquid crystal display panel having source signal lines and gate signal lines arranged in matrix form and liquid crystal display elements using OCB mode liquid crystal, the liquid crystal display elements being provided at intersections between the source signal lines and gate signal lines; a gate driver that supplies a gate signal to said gate signal lines; a source driver that supplies a voltage corresponding to gradation of display data to said source signal lines during a display period; temperature detection means of detecting temperature; and correcting means of correcting display data for generating the source signal to display data according to the detected temperature, wherein the source signal is generated based on the corrected display data.

### BACKGROUND OF THE INVENTION

1. Field of the Invention

The present invention relates to a liquid crystal display device using an OCB mode liquid crystal and a method of driving the liquid crystal display device.

2. Prior Art of the Invention

A liquid crystal display device is thin and light, and has been used in an increasingly wide range of application as a substitute for a conventional cathode ray tube in recent years. However, a TN (Twisted Nematic) aligned liquid crystal panel which is currently used in a wide range has a narrow view angle, a slow response speed and its image quality is inferior to that of a cathode ray tube, for example, when a moving image is displayed its image appears to linger.

In contrast, a liquid crystal display device using an OCB (Optically Compensated Bend) mode featuring high-speed response and a broad view angle is available in recent years. This liquid crystal display device is designed to obtain a wide view angle through visual compensation by bend-aligning the liquid crystal and further combining this with an optical phase compensation film.

FIG. 12 shows a schematic cross-sectional view of a liquid crystal display device using an OCB mode. FIGS. 12(a), (b) are schematic cross-sectional views of the liquid crystal display device using the OCB mode when a voltage is applied and FIG. 12(c) is a schematic cross-sectional view of the liquid crystal display device using the OCB mode when no voltage is applied.

Nematic liquid crystal, as shown as liquid crystal molecule 52 in FIG. 13 (a) or the like, is injected between glass substrates 51 of the liquid crystal display device using an OCB mode and an alignment state of the liquid crystal when no voltage is applied is called a “spray state 53”. By applying a relatively large voltage to this liquid crystal layer at power-up of the liquid crystal display device, it transfers the liquid crystal layer from the spray state 53 shown in FIG. 12 (c) to bent states 54a, 54b shown in FIGS. 12(a), (b). It is a feature of the OCB mode that a display is performed using this bent states 54a, 54b and transmittance of the panel is changed by changing the magnitude of the voltage. The bent state 54a shown in FIG. 12(a) shows a bent state during a white display and the bent state 54b in FIG. 12(b) shows a bent state during a black display.

FIG. 13 shows a relationship between a voltage and brightness of a liquid crystal display device using an OCB mode. Reference numeral 55 denotes a relationship between the voltage and brightness when the temperature is 30° C. and 56 denotes a relationship between the voltage and brightness when the temperature is 55° C. When the temperature is 30° C., as indicated by reference numeral 55, in the relationship between the voltage and brightness, the brightness decreases as the voltage increases, the brightness reaches a minimum at a position Q, then the brightness increases slightly as the voltage increases. Thus, when the voltage increases from the position of Q, the brightness shifts to an increase. While this tendency is also seen in TN liquid crystal, the degree of increase in brightness is much greater than that of the TN liquid crystal. When the temperature is 55° C., as indicated by reference numeral 56, in the relationship between the voltage and brightness, the brightness decreases as the voltage increases and the brightness reaches a minimum at a point P and then the brightness increases slightly as the voltage increases. Thus, when the voltage increases from the position P, the brightness shifts to an increase. While this tendency is also seen in TN liquid crystal, the degree of increase of brightness is by far greater than that of the TN liquid crystal. Thus, the relationship between the brightness and voltage changes when the temperature changes.

FIG. 14 shows a relationship between gradation and brightness in the vicinity of a voltage where the brightness reaches a minimum in the cases of 30° C., 45° C. and 55° C. The gradation corresponding to the minimum brightness increases as the temperature increases. Since the liquid crystal display device using the OCB mode is normally white, with regard to a voltage, a voltage corresponding to the minimum brightness decreases as the temperature increases. Thus, the relationship between the voltage and brightness of the liquid crystal display device using the OCB mode changes as the temperature changes and the gradation (voltage) corresponding to the minimum brightness in particular increases (decreases) as the temperature increases.

Furthermore, with regard to the gradation with a lower value than the graduation with the minimum brightness, the brightness increases as the gradation decreases. Though this tendency is also seen in TN liquid crystal, this tendency is by far greater than the TN liquid crystal. With regard to the voltage, as described above, the brightness increases as the voltage increases at a voltage greater than the voltage corresponding to the minimum brightness. Though this tendency is also seen in TN liquid crystal, the degree of increase in brightness is by far greater than that of the TN liquid crystal.

However, as is also seen in a TN aligned liquid crystal display device, in the case of a liquid crystal display device using an OCB mode in particular, when the temperature increases, the voltage corresponding to the minimum brightness decreases, and therefore even when a black display is performed, the display may appear rather bright. That is, the display appears bright because when the voltage corresponding to the minimum brightness applied before the temperature increased is applied after the temperature increases, the voltage corresponding to the minimum brightness decreases.

Furthermore, the relationship between the brightness and voltage changes according to the temperature, and therefore when the temperature changes, the brightness which is different from the brightness to be actually displayed is displayed.

That is, in the case of the conventional liquid crystal display device using an OCB mode, when the temperature increases, even in the case of a black display, optical compensation cannot be attained and a black color is displayed brightly, which results in a problem of reducing contrast.

Furthermore, the conventional liquid crystal display device using an OCB mode has a problem that when the temperature changes, brightness displayed differs from the brightness to be actually displayed.

In view of the above described problems, it is an object of the present invention to provide a liquid crystal display device and a method of driving the liquid crystal display device capable of realizing a black display with minimum brightness even if temperature increases.

In view of the above described problems, it is an object of the present invention to provide a liquid crystal display device capable of displaying the brightness to be displayed even when temperature changes and a method of driving the liquid crystal display device.

### SUMMARY OF THE INVENTION

The 1^{st} aspect of the present invention is a liquid crystal display device comprising:
a liquid crystal display panel having source signal lines and gate signal lines arranged in matrix form and liquid crystal display elements, said liquid crystal display elements being provided at intersections between said source signal lines and gate signal lines;
a gate driver that supplies a gate signal to said gate signal lines;
a source driver that supplies a source signal to said source signal lines;
temperature detection means of detecting temperature; and
source driver driving means of supplying a source driver drive voltage according to said detected temperature to said source driver.

The 2^{nd} aspect of the present invention is a liquid crystal display device comprising:
a liquid crystal display panel having source signal lines and gate signal lines arranged in matrix form and liquid crystal display elements, said liquid crystal display elements being provided at intersections between said source signal lines and gate signal lines;
a gate driver that supplies a gate signal to said gate signal lines;
a source driver that supplies a source signal to said source signal lines;
temperature detection means of detecting temperature; and
correcting means of correcting display data for generating said source signal to display data according to said detected temperature,
wherein said source signal is generated based on the corrected display data.

The 3^{rd} aspect of the present invention is the liquid crystal display device according to the 2^{nd} aspect of the present invention, wherein that said correcting means corrects said display data means carrying out gamma correction according to said detected temperature.

The 4^{th} aspect of the present invention is the liquid crystal display device according to the 2^{nd} aspect of the present invention, wherein that said correcting means corrects said display data means correcting the value of said display data having a value of 0 out of said display data to a first value which is a value according to the detected temperature, and
correcting a second value which is a value of said display data whose signal level is non-zero out of said display data, to a value obtained by adding the first value to a value obtained by subtracting the first value from a third value, which is a maximum value of the value of said display data, then dividing the subtraction result by the third value and multiplying by the second value.

The 5^{th} aspect of the present invention is the liquid crystal display device according to the 2^{nd} aspect of the present invention, wherein that said correcting means corrects said display data means correcting said display data whose value is a predetermined value or less out of said display data.

The 6^{th} aspect of the present invention is the liquid crystal display device according to the 1^{st} or the 2^{nd} aspect of the present invention, wherein said liquid crystal display element is a liquid crystal display element using OCB mode liquid crystal.

The 7^{th} aspect of the present invention is a liquid crystal display device driving method of driving a liquid crystal display device, said liquid crystal display device comprising:
a liquid crystal display panel having source signal lines and gate signal lines arranged in matrix form and liquid crystal display elements, said liquid crystal display elements being provided at intersections between said source signal lines and gate signal lines;
a gate driver that supplies a gate signal to said gate signal lines; and
a source driver which supplies a source signal to said source signal line, said method comprising:
a temperature detecting step of detecting temperature; and
a source driver driving step of supplying a source driver drive voltage according to said detected temperature to said source driver.

The 8^{th} aspect of the present invention is a liquid crystal display device driving method of driving a liquid crystal display device, said liquid crystal display device comprising:
a liquid crystal display panel having source signal lines and gate signal lines arranged in matrix form and liquid crystal display elements, said liquid crystal display elements being provided at intersections between said source signal lines and gate signal lines;
a gate driver that supplies a gate signal to said gate signal lines; and
a source driver which supplies a source signal to said source signal line, said method comprising:
a temperature detecting step of detecting temperature; and
a correcting step of correcting display data for generating said source signal to display data according to said detected temperature,
wherein said source signal is generated based on the corrected display data.

The 9^{th} aspect of the present invention is the liquid crystal display device according to the 7^{th} or the 8^{th} aspect of the present invention, wherein said liquid crystal display element is a liquid crystal display element using OCB mode liquid crystal.

The present invention provides a liquid crystal display device and a method of driving the liquid crystal display device capable of realizing a black display with minimum brightness even if temperature increases.

Furthermore, the present invention provides a liquid crystal display device capable of displaying the brightness to be displayed even when temperature changes and a method of driving the liquid crystal display device.

### BRIEF DESCRIPTION OF THE DRAWINGS

FIG. 1 is a block diagram showing the configuration of a liquid crystal display device according to a first embodiment of the present invention;

FIG. 2 is a block diagram showing the detailed structure of a controller circuit 6 according to a first embodiment of the present invention;

FIG. 3 illustrates an example of a gamma correction table according to the first embodiment of the present invention;

FIG. 4 illustrates an example of the gamma correction table when input display data having a predetermined value or below out of the input display data in the first embodiment of the present invention is corrected;

FIG. 5 illustrates a method of correcting the input display data according to the first embodiment of the present invention;

FIG. 6 is a block diagram showing the structure of a liquid crystal display device according to a second embodiment of the present invention;

FIG. 7 illustrates the detailed structure of the liquid crystal drive voltage generation circuit according to the second embodiment of the present invention;

FIG. 8 illustrates a relationship between gradation of input display data and an output voltage of a source driver 4, and a source driver drive voltage (AVDD) according to the second embodiment of the present invention;

FIG. 9 illustrates an example of the structure of a source driver drive voltage generation circuit 15 according to the second embodiment of the present invention;

FIG. 10 illustrates another example of the structure of the source driver drive voltage generation circuit 15 according to the second embodiment of the present invention;

FIG. 11 illustrates another example of the structure of the source driver drive voltage generation circuit 15 according to the second embodiment of the present invention;

FIG. 12(a) is a schematic cross-sectional view of a conventional liquid crystal display device using an OCB mode when a voltage is applied (white display state), FIG. 12(b) is a schematic cross-sectional view of the conventional liquid crystal display device using an OCB de when a voltage is applied (black display state) and FIG. 12(c) is a schematic cross-sectional view of the conventional liquid crystal display device using an OCB mode when no voltage is applied;

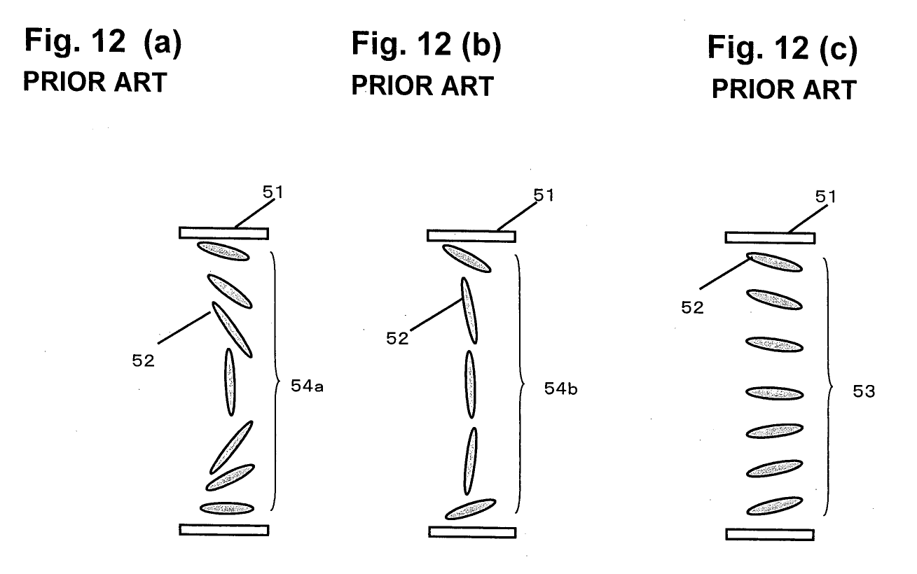

FIG. 13 illustrates a relationship between voltage and brightness of an OCB mode liquid crystal display device; and

FIG. 14 illustrates a relationship between gradation in the vicinity of minimum brightness and brightness in the OCB mode liquid crystal display device.

### DESCRIPTION OF REFERENCE NUMERALS

1 Liquid crystal display device
2 Liquid crystal display panel
3 Gate driver
4 Source driver
5 Liquid crystal drive voltage generation circuit
6 Controller circuit
7 Temperature detection means
8 Input power supply
9 Display data generation
10 Image signal processing circuit
11 Timing control circuit
12 Liquid crystal display device
13 Liquid crystal drive voltage generation circuit
14 Controller circuit
15 Source driver drive voltage generation circuit
16 Gate driver drive voltage generation circuit
17 Opposite signal voltage generation circuit

### PREFERRED EMBODIMENTS OF THE INVENTION

With reference now to the attached drawings, embodiments of the present invention will be explained below.

### First Embodiment

First, a first embodiment will be explained.

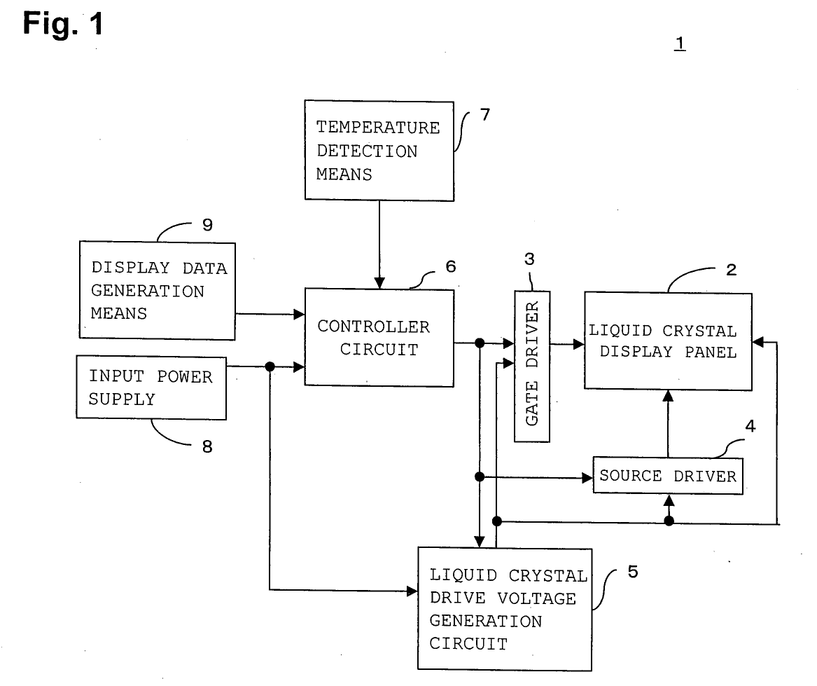

FIG. 1 shows a block diagram of a liquid crystal display device 1 of a first embodiment.

A liquid crystal display device 1 is a liquid crystal display device using OCB mode liquid crystal.

The liquid crystal display device 1 is constructed of a liquid crystal display panel 2, a gate driver 3, a source driver 4, a liquid crystal drive voltage generation circuit 5, a controller circuit 6, a temperature detection means 7, an input power supply 8 and a display data generation means 9.

The liquid crystal display panel 2 is a display panel having source signal lines and gate signal lines arranged in matrix form and liquid crystal elements provided at intersections between the source signal lines and gate signal lines and using OCB mode liquid crystal.

The gate driver 3 is a circuit that supplies a selection scanning signal for carrying out linear sequential scanning of each gate signal line of the liquid crystal display panel 2.

The source driver 4 is a circuit that supplies each source signal line of the liquid crystal display panel 2 with an image signal voltage.

The liquid crystal drive voltage generation circuit 5 is a circuit that supplies a source driver drive voltage (AVDD) to the source driver 4, supplies a gate driver drive voltage (VGG, VEE) to the gate driver 3 and supplies an opposite signal electrode drive voltage (VCOM) to the opposite signal electrode.

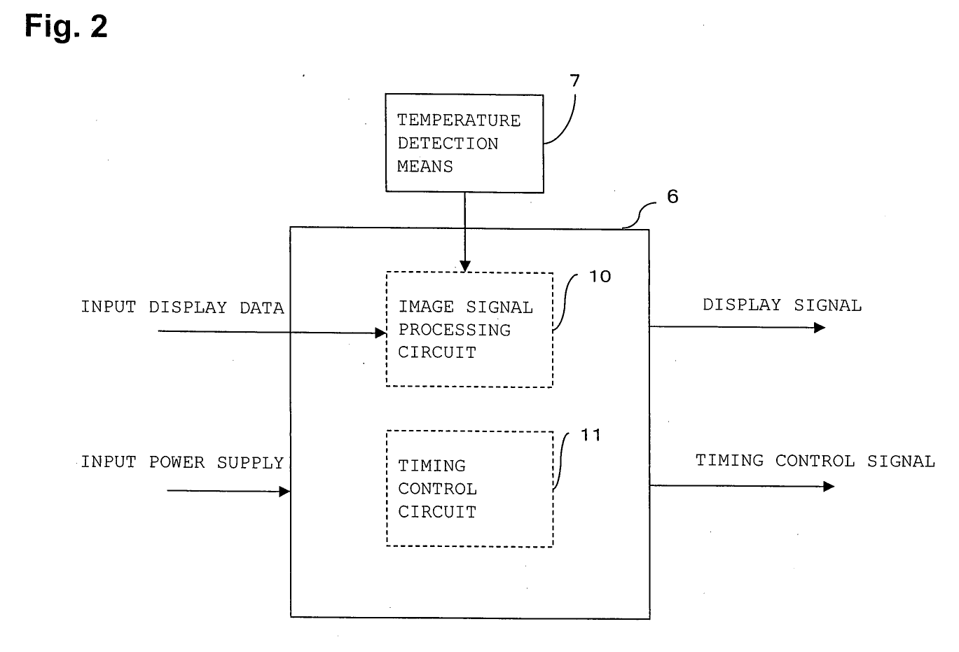

The controller circuit 6 is a circuit which controls image signal processing and drive timing. As shown in FIG. 2, the controller circuit 6 is constructed of an image signal processing circuit 10 and a timing control circuit 11. The image signal processing circuit 10 receives input display data generated by the display data generation means 9, corrects the input display data to display data according to the temperature detected by the temperature detection means 7 and outputs a display signal corresponding to the corrected display data. Furthermore, the timing control circuit 11 is a circuit which sends a timing control signal to the source driver 4, gate driver 3 and liquid crystal drive voltage generation circuit 5.

The temperature detection means 7 is means of detecting the temperature of the liquid crystal display panel 2.

The input power supply 8 is means of supplying power for the liquid crystal display device 1 to operate.

The display data generation means 9 is means of generating display data displayed on the liquid crystal display panel 2 and means of reading, for example, image data stored in a frame buffer and outputting the image data read.

The image signal processing circuit 10 of this embodiment is an example of correction means of the present invention.

Next, the operation of this embodiment will be explained.

The input power supply 8 is supplied to the controller circuit 6 and liquid crystal drive voltage generation circuit 5 and the controller circuit 6 is started first. Then, the controller circuit 6 sends an image display signal and timing control signal to the source driver 4, sends a timing control signal to the gate driver 3 and sends a timing control signal to the liquid crystal drive voltage generation circuit 5.

The liquid crystal drive voltage generation circuit 5 supplies a source driver drive voltage (AVDD) to the source driver 4, supplies a gate driver drive voltage (VGG, VEE) to the gate driver 3 and supplies an opposite signal electrode drive voltage (VOCM) to the opposite signal electrode, allowing a display operation.

On the other hand, the temperature detection means 7 detects the temperature of the liquid crystal display panel 2 and outputs the temperature detection result to the image signal processing circuit 10. The image signal processing circuit 10 receives the input display data generated by the display data generation means 9, corrects the input display data to display data according to the temperature detected by the temperature detection means 7 and outputs a display signal corresponding to the corrected display data.

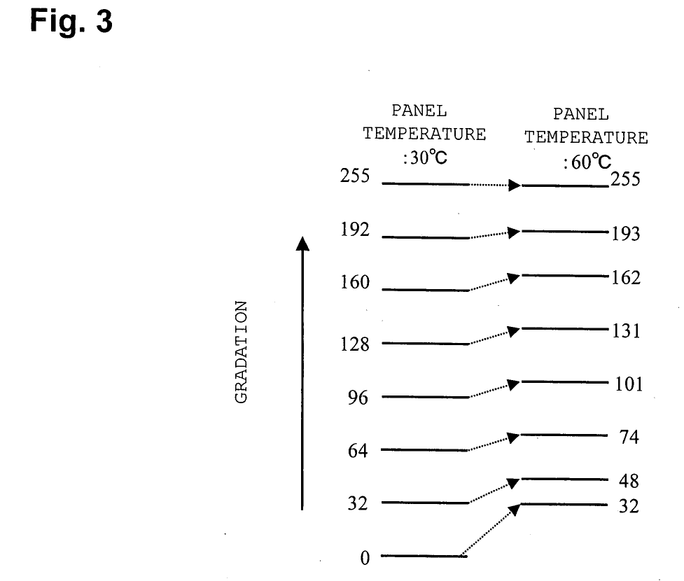

That is, the image signal processing circuit 10 has a gamma correction table for carrying out gamma correction according to the temperature of the liquid crystal display panel 2 detected by the temperature detection means 7 and carries out gamma correction on the input display data using the gamma correction table corresponding to the detected temperature. FIG. 3 shows an example of the gamma correction table corresponding to the detected temperature. FIG. 3 shows an example of the gamma correction table showing how each step of gradation is converted when the temperature of the liquid crystal display panel 2 increases to 60° C. relative to the temperature of the liquid crystal display panel 2 of 30° C. The gamma correction table in FIG. 3 is obtained by measuring how each step of gradation of the display data should be changed in order to display the same brightness even if the temperature changes when the temperature increases to 60° C. relative to the temperature of 30° C.

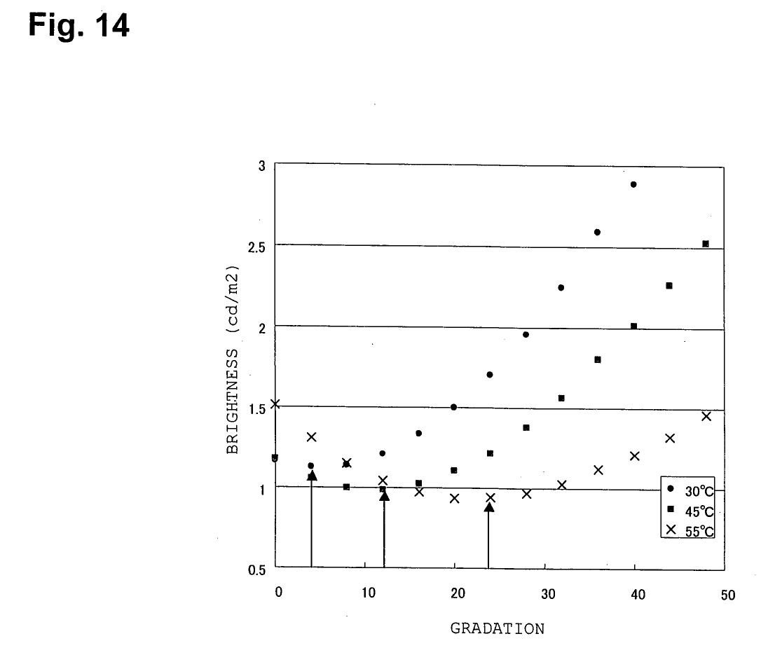

As explained in FIG. 14, when the temperature increases, the gradation corresponding to the minimum brightness increases in a relationship between gradation and brightness. Therefore, relative to the temperature of the liquid crystal display panel 2 of 30° C., if the temperature of the liquid crystal display panel 2 increases to 60° C., it is necessary to carry out gamma correction so that the gradation of the input display data increases. For example, as is clear from FIG. 3, when the temperature of the liquid crystal display panel is 60° C., the gradation of the input display data whose gradation is 0 is converted to gradation of 32. Furthermore the gradation of the input display data whose gradation is 64 is converted to gradation of 74.

When the temperature of the liquid crystal display panel 2 is other than 60° C., if the temperature of the liquid crystal display panel changes relative to the temperature of 30° C., in order to display the same brightness even if the temperature changes, it is possible to obtain a gamma correction table according to the temperature by measuring how each step of gradation of the display data should be changed beforehand.

The image signal processing circuit 10 carries out gamma correction on the input display data using such a gamma correction table according to the temperature, and can thereby perform a black display even if the temperature increases and display the brightness to be displayed even when the temperature changes.

This embodiment has been explained assuming that when a gamma correction table is created, if the temperature changes relative to the temperature of 30° C., the same brightness is displayed even if the temperature changes by measuring how each step of gradation of the display data should be changed beforehand, but the temperature to be used as a reference is not limited to 30° C. and can be any temperature other than 30° C.

This embodiment has been explained assuming that gamma correction is carried out over the entire gradation of the input display data, but the present invention is not limited to this. It is also possible to carry out gamma correction on only the low gradation portion out of the gradation of the input display data.

That is, when only black color gradation is subjected to gamma correction, the continuity of the input display data is lost through the gamma correction. Therefore, to keep the continuity of the input display data, it is also possible to carry out gamma correction on only the low gradation portion out of the gradation of the input display data.

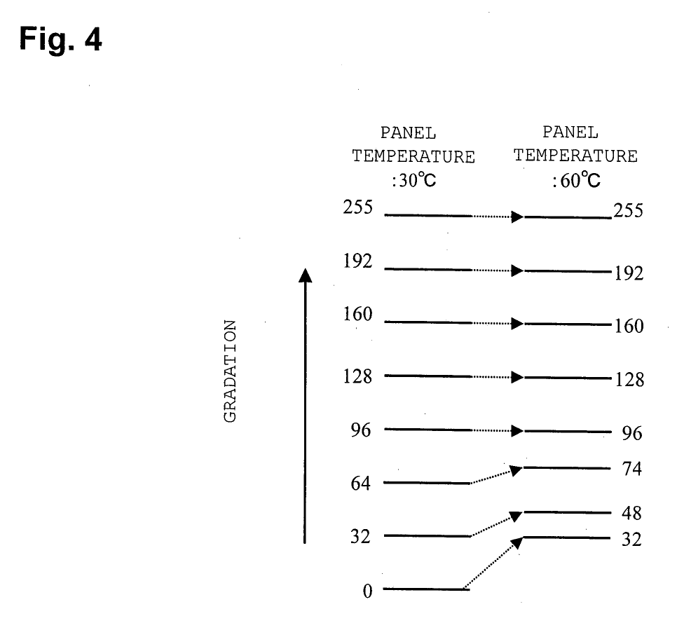

Furthermore, when the high gradation portion is subjected to gamma correction, a white color is likely to become more outstanding compared to the low gradation portion. Therefore, as shown in FIG. 4, it is possible to avoid the problem that the white color display becomes more outstanding in the high gradation portion by correcting the input display data having a predetermined value or below out of the input display data.

For example, it is obvious from FIG. 4 that only the low gradation portion (high voltage section) whose gradation of input display data is less than 128 has been subjected to gamma correction.

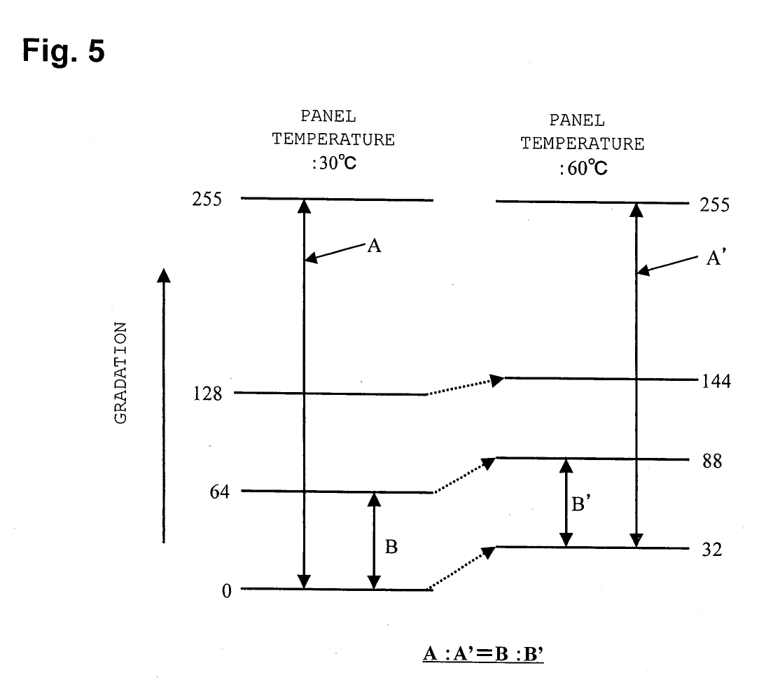

Furthermore, this embodiment has been explained assuming that the input display data is subjected to gamma correction according to the temperature of the liquid crystal display panel 2, but it is also possible to apply correction other than gamma correction to the input display data. FIG. 5 shows such a method of correcting input display data.

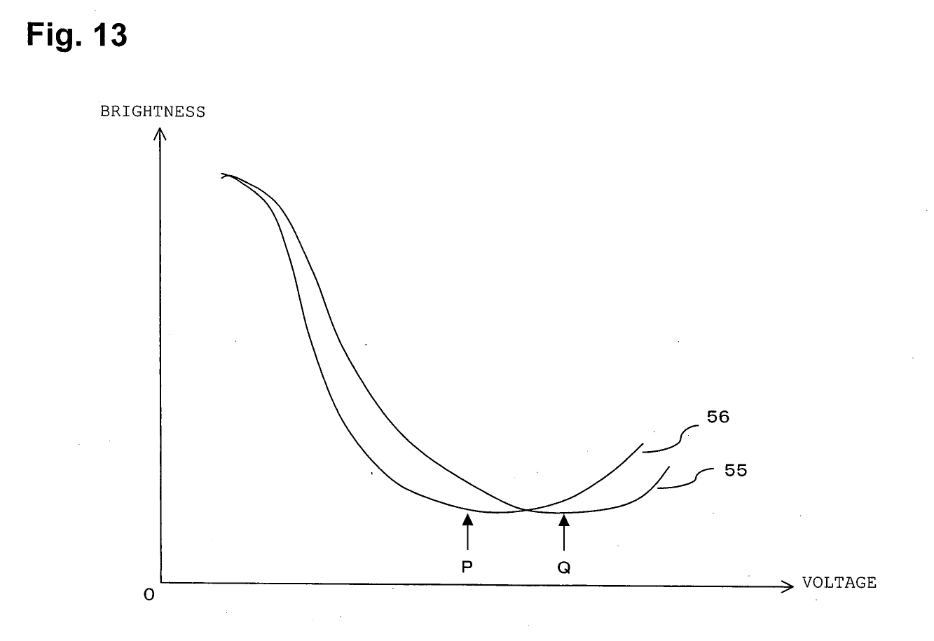

That is, FIG. 5 shows how gradation of the input display data should be corrected when the temperature of the liquid crystal display panel 2 is 60° C. relative to the case where the temperature of the liquid crystal display panel 2 is 30° C. That is, the gradation when the temperature in FIG. 5 is 30° C. is 0, that is, the gradation of a black display corresponds to the point Q in the relationship 55 between the voltage and brightness at 30° C. which has been explained in FIG. 13. In FIG. 13, the point Q at which the brightness becomes a minimum when the temperature increases moves in the direction in which the voltage (gradation) is small (large) as the point P, for example. Furthermore, when the temperature increases, it is necessary to set a voltage (gradation) corresponding to the point at which the brightness becomes a minimum in order to perform a black display. FIG. 5 shows that when the gradation of the input display data to perform a black display when the temperature is 30° C. is 0, it is necessary to convert the gradation to 32 in order that the black display can be performed even if the temperature changes. Thus, though the gradation corresponding to the black display at the temperature of 30° C. is 0, but when the temperature increases to 60° C., the gradation corresponding to the black display becomes 32.

Then, the gradation of the input display data other than the black display is converted as follows. For example, gradation 64 at the temperature of 30° C. is converted in such a way that the following Formula 1 is held assuming that the length from gradation 0 to gradation 64 is B, the length from gradation 0 to gradation 255 is A, the length from gradation 32 to gradation 255 is A′ and the length from gradation 32 to the converted gradation is B′.
A:A′=B:B′ (Formula 1)

It is evident from Formula 1 that the gradation 64 is converted to gradation 88. Gradation other than gradation 64 is also converted according to Formula 1.

To put Formula 1 in another way, the gradation X1 before conversion is converted to gradation X2 after conversion based on the following Formula 2 at 60° C. assuming that the gradation of the black display at 30° C. is 0, gradation of the black display at 60° C. is L1, gradation before conversion at 30° C. is X1 and a maximum value of gradation is Lmax.
X2=L1+(Lmax−L1)×X1/Lmax (Formula 2)

Furthermore, Formula 2 can also be used to convert gradation at the temperature other than 60° C. That is, even when the temperature is temperature T other than 60° C., the gradation X2 after conversion when the temperature is T can be obtained using Formula 2 assuming that the gradation of the black display at the temperature T is L1, that is, gradation 0 at 30° C. is converted to gradation L1 at the temperature T, gradation before conversion at 30° C. is X1 and the maximum value of gradation is Lmax.

Thus, using Formula 2, when the temperature of the liquid crystal display panel 2 changes relative to the case where the temperature is 30° C., it is possible to obtain gradation after the temperature changes. The image signal processing circuit 10 outputs the gradation of the input display data after conversion as a display signal using Formula 2 when the temperature changes relative to the gradation when the temperature is 30° C. Thus, the image signal processing circuit 10 converts the gradation of the input display data according to the temperature, and can thereby obtain effects similar to those when the input display data is subjected to gamma correction. Furthermore, when gamma correction is carried out if a table for converting the gradation before gamma correction to gradation after gamma correction is used, it is necessary to provide a memory to store this table in the controller, etc., of the liquid crystal display device and store this table in this memory. However, this embodiment obtains the gradation after the temperature changes using Formula 2 without using such a table, it is not necessary to provide a memory in the controller, etc., of the liquid crystal display device and it is possible to save the memory.

### Second Embodiment

Next, a second embodiment will be explained.

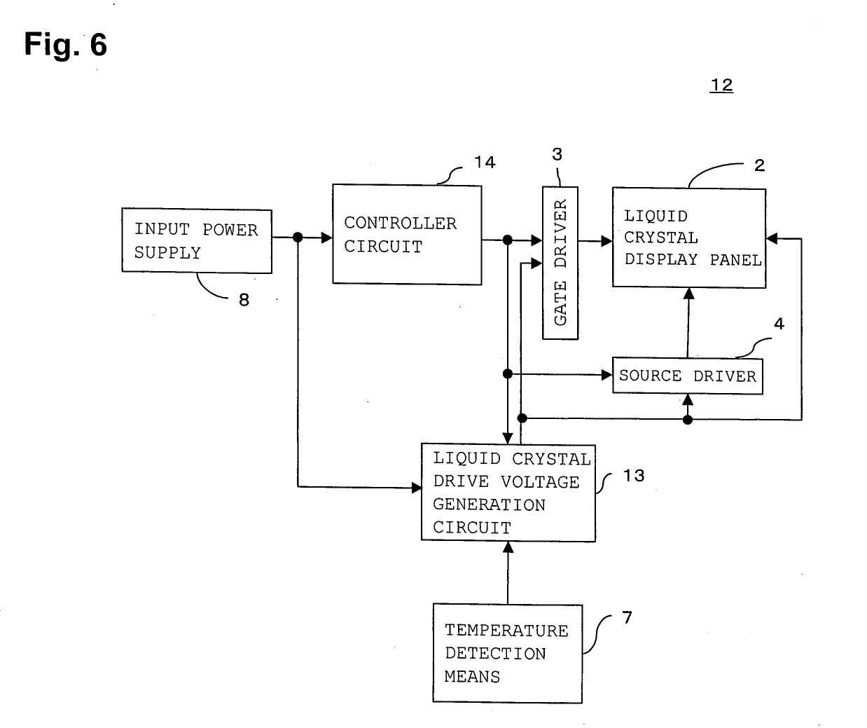

FIG. 6 shows a block diagram of a liquid crystal display device 12 according to a second embodiment.

The liquid crystal display device 12 is a liquid crystal display device using OCB mode liquid crystal as in the case of the first embodiment.

The liquid crystal display device 12 is constructed of a liquid crystal display panel 2, a gate driver 3, a source driver 4, a liquid crystal drive voltage generation circuit 13, a controller circuit 14, temperature detection means 7 and an input power supply 8. As in the case of the first embodiment, the second embodiment is also provided with a display data generation circuit, which is not shown for simplicity.

The liquid crystal display device 12 according to the second embodiment differs from the liquid crystal display device 1 according to the first embodiment in the controller circuit and liquid crystal drive voltage generation circuit 13.

That is, the controller circuit 14 is a circuit which controls image signal processing and drive timing, but unlike the first embodiment, it is a circuit which does not correct input data according to temperature.

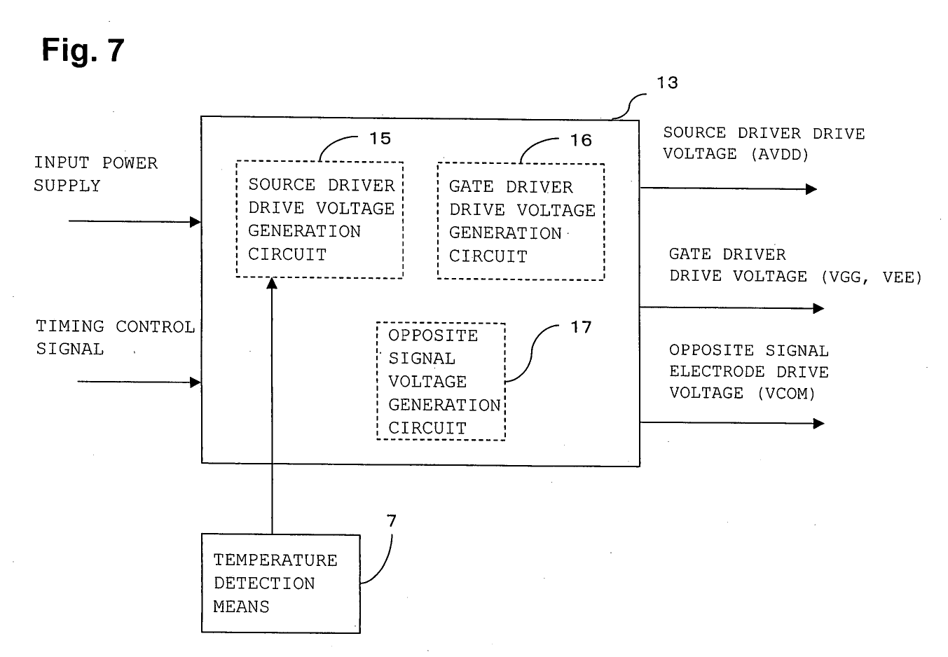

Furthermore, as shown in FIG. 7, the liquid crystal drive voltage generation circuit 13 is a circuit in a multi-output structure made up of a source driver drive voltage generation circuit 15, agate driver drive voltage generation circuit 16 and an opposite signal voltage generation circuit 17. That is, the source driver drive voltage generation circuit 15 of the liquid crystal drive voltage generation circuit 13 is a circuit which supplies a source driver drive voltage (AVDD) to the source driver 9. The gate driver drive voltage generation circuit 16 of the liquid crystal drive voltage generation circuit 13 is a circuit which supplies a gate driver drive voltage (VGG, VEE) to the gate driver 10. The opposite signal voltage generation circuit 17 of the liquid crystal drive voltage generation circuit 13 is a circuit which supplies an opposite signal electrode drive voltage (VCOM) to the opposite signal electrode.

Furthermore, the source driver drive voltage generation circuit 15 is a circuit which supplies a source driver drive voltage (AVDD) according to the temperature of the liquid crystal display panel 2 detected by the temperature detection means to the source driver.

The rest of the structure is the same as that of the first embodiment, and therefore explanations thereof will be omitted.

The source driver drive voltage generation circuit 15 of this embodiment is an example of the source driver drive means of the present invention.

Next, the operation of this embodiment will be explained.

The input power supply 8 is supplied to the controller circuit 14 and liquid crystal drive voltage generation circuit 13 and the controller circuit 14 is started first. Then, the controller circuit 14 sends an image display signal and timing control signal to the source driver 4, sends a timing control signal to the gate driver 3 and sends a timing control signal to the liquid crystal drive voltage generation circuit 13.

The source driver drive voltage generation circuit 15 of the liquid crystal drive voltage generation circuit 13 supplies a source driver drive voltage (AVDD) to the source driver 4. Furthermore, the gate driver drive voltage generation circuit 16 of the liquid crystal drive voltage generation circuit 13 supplies a gate driver drive voltage (VGG, VEE) to the gate driver 3. Furthermore, the opposite signal voltage generation circuit 17 of the liquid crystal drive voltage generation circuit 13 supplies an opposite signal electrode drive voltage (VCOM) to the opposite signal electrode. In this way, the liquid crystal display device 12 can perform a display operation.

On the other hand, the temperature detection means 7 detects the temperature of the liquid crystal display panel 2 and outputs the temperature detection result to the source driver drive voltage generation circuit 15 of the liquid crystal drive voltage generation circuit 13. The source driver drive voltage generation circuit 15 supplies a source driver drive voltage (AVDD) according to the temperature detected by the temperature detection means 7 to the source driver 4. The source driver drive voltage (AVDD) is an analog voltage of the source driver 4.

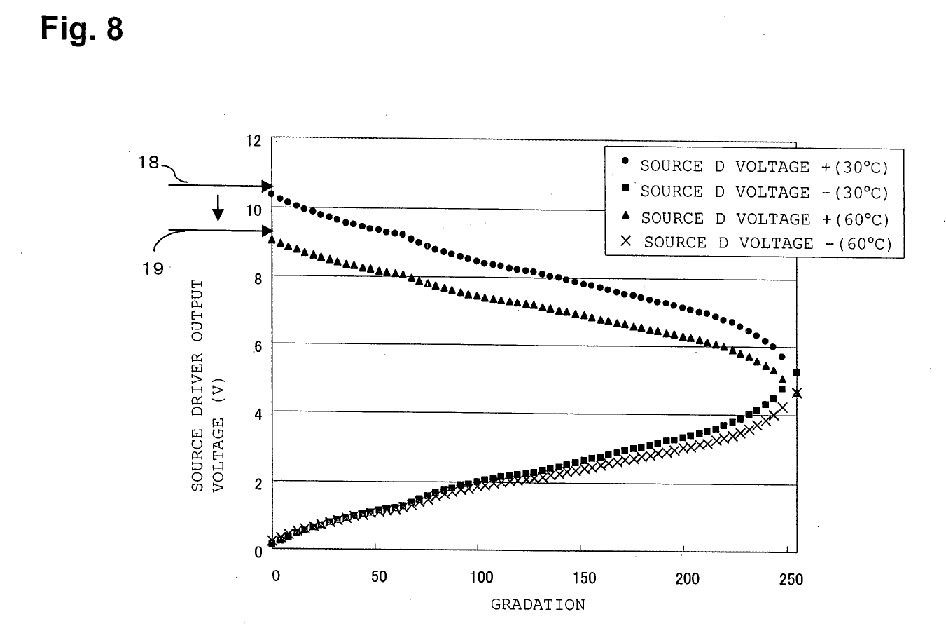

FIG. 8 shows a relationship between the gradation of input display data and the output voltage of the source driver 4, and the source driver drive voltage (AVDD). Furthermore, FIG. 8 shows the source driver drive voltage (AVDD) when the temperature of the liquid crystal display panel is 30° C. as AVDD (30° C.) 18. Furthermore, FIG. 8 shows the source driver drive voltage (AVDD) when the temperature of the liquid crystal display panel is 60° C. as AVDD (60° C.) 19. The voltage of AVDD (60° C.) 19 is lower than that of AVDD (30° C.) 18. That is, as explained in FIG. 13, when the temperature rises, the voltage corresponding to the minimum brightness decreases in the relationship between the voltage and brightness. Therefore, the voltage corresponding to the minimum brightness is smaller when the temperature of the liquid crystal display panel 2 is 60° C. than when the temperature of the liquid crystal display panel 2 is 30° C. Then, the voltage corresponding to the minimum brightness corresponds to a black display, or in terms of voltage, a voltage corresponding to the source driver drive voltage (AVDD). Therefore, the source driver drive voltage generation circuit 15 sets AVDD (60° C.) 19 rather than AVDD (30° C.) 18 to a lower voltage.

Thus, by setting the AVDD (30° C.) 18 and AVDD (60° C.) 19 to voltages corresponding to the minimum brightness at the respective temperatures of the liquid crystal display panel 2, it is possible to solve the problem that even in the case of a black display, optical compensation is not possible and the black color is displayed brightly, thus reducing contrast.

Furthermore, the source driver drive voltage generation circuit 15 sets the source driver drive voltage (AVDD) to a voltage according to the temperature of the liquid crystal display panel 2 detected by the temperature detection means 7 and the output voltage to the source driver 4 thereby changes at each step of gradation. As shown in FIG. 8, for example, the source driver drive voltage (AVDD) is set to a lower value when the temperature of the liquid crystal display panel 2 is 60° C. rather than when the temperature of the liquid crystal display panel 2 is 30° C., and thereby the output voltage to the source driver 4 at each step of gradation is also lower when the temperature of the liquid crystal display panel 2 is 60° C. than when the temperature of the liquid crystal display panel 2 is 30° C. Thus, by changing the source driver drive voltage (AVDD) according to the temperature, it is also possible to change the output voltage to the source driver 4 at each step of gradation. Therefore, even when the temperature of the liquid crystal display panel 2 changes, it is possible to display the brightness to be displayed.

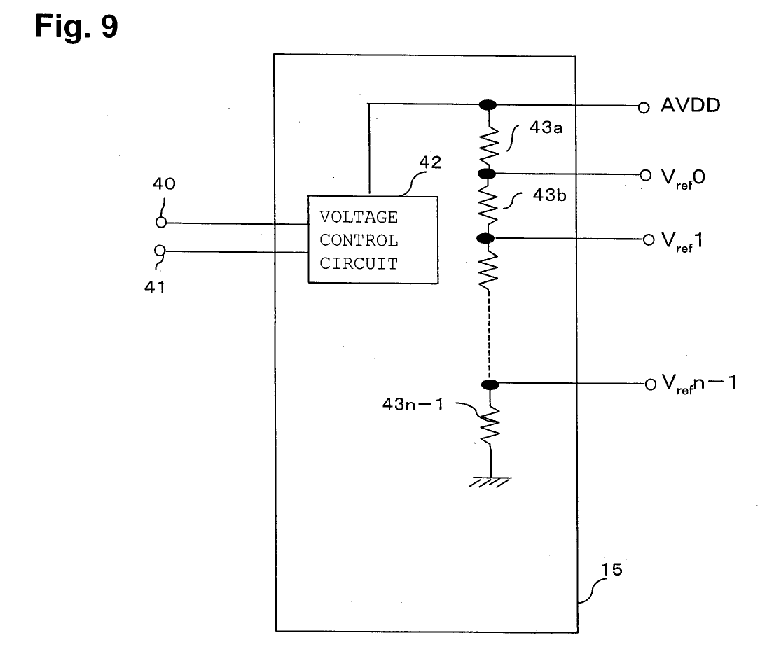

FIG. 9 shows an example of the structure of the source driver drive voltage generation circuit 15 capable of setting the source driver drive voltage (AVDD) to a voltage according to the temperature of the liquid crystal display panel 2 detected by the temperature detection means 7.

The source driver drive voltage generation circuit 15 is constructed of a voltage control circuit 42 and n−1 resistors 43a, 43b, . . . , 43n−1. The voltage control circuit 42 is a circuit which receives a supply voltage from the input power supply 8 through a terminal 40, receives a temperature detection signal including temperature-related information detected by the temperature detection means 7 through a terminal 41 and outputs a source driver drive voltage (AVDD) according to the temperature. The output of the voltage control circuit 42 is connected to a circuit which divides the voltage of the output of the voltage control circuit 42 through n resistors 43a, 43b, . . . , 43n. N voltages Vref0, Vref1, . . . , Vrefn−1 obtained by dividing the source driver drive voltage (AVDD), source driver drive voltage (AVDD) through resistors are output from the circuit which divides the voltage of the output of the voltage control circuit 42 through resistors.

Next, the operation of the source driver drive voltage generation circuit 15 shown in FIG. 9 will be explained.

The supply voltage supplied from the input power supply 8 is supplied to the terminal 40. Furthermore, a temperature detection signal including temperature-related information detected by the temperature detection means 7 is input to the terminal 41.

The voltage control circuit 42 sets the voltage supplied from the input power supply 40, for example, as shown in FIG. 8 to a lower value when the temperature of the liquid crystal display panel 2 is 60° C. than when the temperature of the liquid crystal display panel 2 is 30° C. as the source driver drive voltage (AVDD). That is, the output voltage to the source driver 4 at each step of gradation is also lower when the temperature of the liquid crystal display panel 2 is 60° C. than when the temperature of the liquid crystal display panel 2 is 30° C. Thus, the voltage control circuit 42 changes the source driver drive voltage (AVDD) according to the temperature.

The source driver drive voltage (AVDD) which is the output of the voltage control circuit 42 is divided through resistors by the circuit made up of n resistors 43a, 43b, . . . , 43n−1 and n voltages Vref0, Vref1, . . . , Vrefn−1 resulting from a voltage divided through resistors together with the source driver drive voltage (AVDD) are output from the source driver drive voltage generation circuit 15. These output voltages are supplied to the source driver 4 via a flexible printed circuit board (not shown).

The source driver 4 generates a voltage corresponding to each step of gradation using AVDD, n voltages Vref0, Vref1, . . . , Vrefn−1.

Thus, the voltage control circuit 42 of the source driver drive voltage generation circuit 15 shown in FIG. 9 can automatically determine the respective voltages of Vref0, Vref1, etc., corresponding to gradation other than a black color in a well-balanced manner by only adjusting the source driver drive voltage (AVDD) corresponding to the black color voltage according to the temperature. Moreover, the source driver drive voltage generation circuit 15 can reduce the output voltages of source driver drive voltage (AVDD), Vref0, Vref1, . . . , Vrefn−1 as the temperature increases, that is, can reduce average power consumed by the liquid crystal display device 12 as the temperature increases, and can thereby also prevent generation of heat from the liquid crystal display device 12 even when the temperature increases.

Furthermore, the first embodiment has performed digital processing of correcting gradation of display data, but in this case, if the temperature rises, the number of steps of gradation that the displayed data can takemaybe reduced as aresult of correction. For example, in the case shown in FIG. 5, when the panel temperature is 30° C., the number of steps of gradation of the display data is 256, whereas when the panel temperature increases to 60° C., the display data is corrected to a range of gradation from 32 to 255. That is, the number of steps of gradation becomes 224 and the number of steps of gradation of the display data actually displayed is reduced.

In contrast, the second embodiment corrects AVDD, n voltages Vref0, Vref1, . . . , Vrefn−1 to be supplied to the source driver 4 in an analog manner, and therefore the difference in voltage among steps of gradation of the display data may be reduced, but the number of steps of gradation of the display data is never reduced.

In FIG. 9, it is also possible to directly connect the terminal 40 to the resistor 43a and use a thermistor as the resistor 43a instead of providing the voltage control circuit 42 and temperature detection means 7. That is, the resistor 43a is supplied with a source driver drive voltage (AVDD) of a fixed voltage which does not change according to the temperature. But since the resistor 43a is a thermistor, the resistance value changes according to the temperature. Therefore, the voltage such as Vref0, Vref1, . . . , Vrefn−1 changes according to the temperature because of the resistor 43a. Therefore, such a structure also makes it possible to obtain effects equivalent to those in FIG. 9.

The source driver drive voltage generation circuit 15 is not limited to the one that corrects the source driver drive voltage (AVDD) according to the temperature as explained in FIG. 9, but it is also possible to fix the source driver drive voltage (AVDD) and correct Vref0, etc., according to the temperature.

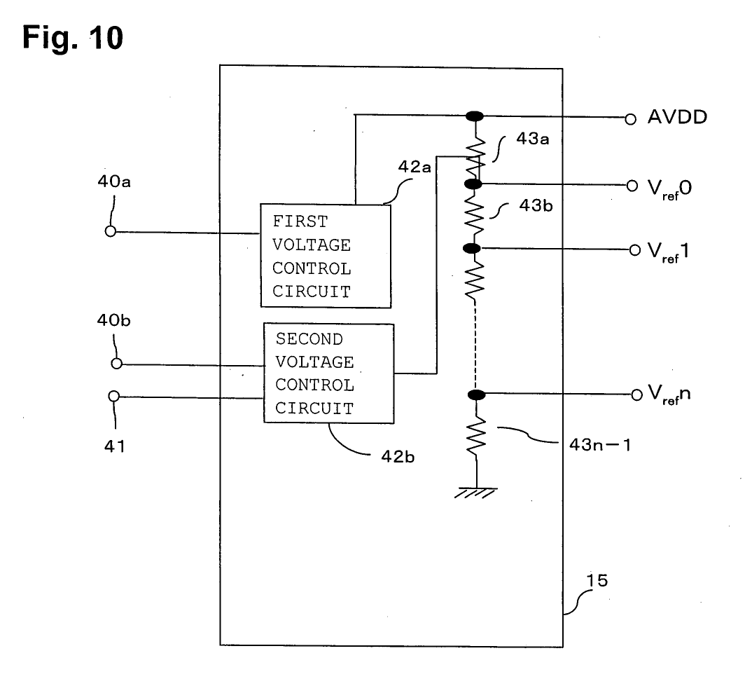

FIG. 10 shows an example of the structure of the source driver drive voltage generation circuit 15 which sets Vref0 to a voltage according to the temperature of the liquid crystal display panel 2 detected by the temperature detection means 7.

The source driver drive voltage generation circuit 15 shown in FIG. 10 is constructed of a first voltage control circuit 42a, a second voltage control circuit 42b and n−1 resistors 43a, 43b, . . . , 43n−1.

The first voltage control circuit 42a is a circuit which receives a supply voltage from the input power supply 8 through the terminal 40a and generates a source driver drive voltage (AVDD) which is a fixed voltage, invariable with temperature. The second voltage control circuit 42b is a circuit which receives a supply voltage from the input power supply 8 through the terminal 40b and inputs a temperature detection signal including temperature-related information detected by the temperature detection means 7 through the terminal 41 and outputs voltage Vref0 according to the temperature. The output of the first voltage control circuit 42a is connected to a resistor 43a of the circuit which divides the voltage of the output of the voltage control circuit 42 through n resistors 43a, 43b, . . . , 43n and the output of the second voltage control circuit 42b is connected to a connecting point between the resistor 43a and resistor 43b.

Next, the operation of the source driver drive voltage generation circuit 15 shown in FIG. 10 will be explained.

The supply voltage supplied from the input power supply 8 is supplied to the terminal 40a and terminal 40b. Furthermore, the temperature detection signal including temperature-related information detected by the temperature detection means 7 is input to the terminal 41.

The first voltage control circuit 42a generates a source driver drive voltage which is a fixed voltage whose voltage value does not change from the supply voltage supplied from the terminal 40a depending on the temperature and supplies the source driver drive voltage to the resistor 43a.

In contrast, the second voltage control circuit 42b sets the supply voltage supplied from the terminal 40b using the temperature detection signal input form the terminal 41 to a lower output voltage when the temperature of the liquid crystal display panel 2 is 60° C. than when the temperature of the liquid crystal display panel 2 is 30° C. That is, the output voltage from the second voltage control circuit 42b when the temperature of the liquid crystal display panel 2 is 60° C. is lower than that when the temperature of the liquid crystal display panel 2 is 30° C. Thus, the second voltage control circuit 42b changes the output voltage according to the temperature.

Therefore, though the source driver drive voltage (AVDD) supplied by the first voltage control circuit 42a is a fixed voltage which does not change with temperature, Vref0 supplied by the second voltage control circuit 42b is a voltage which changes with temperature, and therefore the voltage is divided through resistors with a circuit made up of n resistors 43a, 43b, . . . , 43n−1 and the source driver drive voltage generation circuit 15 outputs not only the source driver drive voltage (AVDD) but also n voltages Vref0, Vref1, . . . , Vrefn−1 whose voltage is divided through resistors. These output voltages are supplied to the source driver 4 via a flexible printed circuit board (not shown).

The source driver 4 generates a voltage corresponding to each step of gradation using AVDD and n voltages Vref0, Vref1, . . . , Vrefn−1.

Thus, the second voltage control circuit 42b of the source driver drive voltage generation circuit 15 shown in FIG. 10 can also be automatically determined for each voltage of Vref1, etc., in a well-balanced manner by only adjusting Vref0 according to the temperature. Moreover, the source driver drive voltage generation circuit 15 reduces the output voltages of Vref0, Vref1, . . . , Vrefn−1, etc., as the temperature increases. That is, it is possible to reduce the average power consumed by the liquid crystal display device 12 as the temperature increases, and therefore even when the temperature rises, it is also possible to prevent generation of heat from the liquid crystal display device 12.

Furthermore, the first embodiment has carried out digital processing of correcting gradation of display data, but in this case, when the temperature rises, the number of steps of gradation of data to be displayed may be reduced as a result of correction. For example, in the case shown in FIG. 5, when the panel temperature is 30° C., the number of steps of gradation is 256, but when the panel temperature rises to 60° C., the display data is corrected within the gradation range of 32 to 255. That is, the number of steps of gradation becomes 224 and the number of steps of gradation that the display data to be actually displayed can take is reduced.

On the contrary, the second embodiment corrects AVDD, n voltages Vref0, Vref1, . . . , Vrefn−1 to be supplied to the source driver 4 in an analog manner, and therefore though the difference in voltage value among steps of gradation of the display data may be reduced, the number of steps of gradation of the display data is never reduced.

Furthermore, the source driver drive voltage generation circuit 15 in FIG. 10 has corrected Vref0 according to the temperature, but it is possible to correct not only Vref0 but also Vrefn−1 according to the temperature.

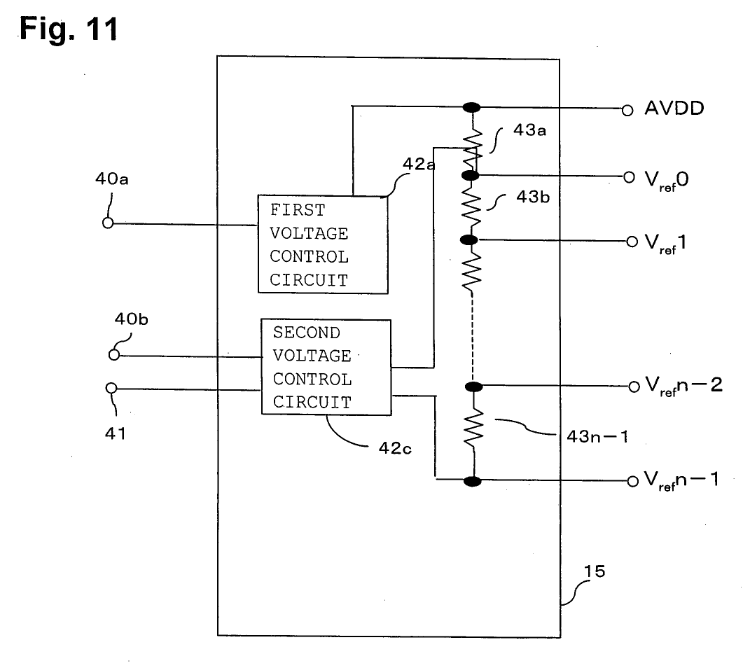

FIG. 11 shows an example of the structure of the source driver drive voltage generation circuit 15 which corrects both Vref0 and Vrefn−1.

The source driver drive voltage generation circuit 15 shown in FIG. 11 is constructed of a first voltage control circuit 42a, a second voltage control circuit 42c, n−1 resistors 43a, 43b, . . . , 43n−1.

The first voltage control circuit 42a is a circuit which receives the supply voltage from the input power supply 8 through the terminal 40a and generates a source driver drive voltage (AVDD) which is a fixed voltage, invariable with temperature. The second voltage control circuit 42c is a circuit which receives the supply voltage from the input power supply 8 through the terminal 40b, inputs a temperature detection signal including temperature-related information detected by the temperature detection means 7 through the terminal 41 and outputs voltage Vref0 according to temperature and Vrefn−1 according to temperature. The output of the first voltage control circuit 42a is connected to the resistor 43a of the circuit which divides the voltage of the output of the voltage control circuit 42 through n resistors 43a, 43b, . . . , 43n and the output of the second voltage control circuit 42c is connected to a connection point between the resistor 43a and resistor 43b, and resistor 42n−1.

Next, the operation of the source driver drive voltage generation circuit 15 shown in FIG. 11 will be explained.

The supply voltage supplied from the input power supply 8 is supplied to the terminal 40a and terminal 40b. Furthermore, the temperature detection signal including the temperature-related information detected by the temperature detection means 7 is input to the terminal 41.

The first voltage control circuit 42a generates a source driver drive voltage of a fixed voltage whose voltage value does not change from the supply voltage supplied from the terminal 40a depending on temperature and supplies the source driver drive voltage to the resistor 43a.

On the contrary, the second voltage control circuit 42c sets the supply voltage supplied from the terminal 40b using the temperature detection signal input from the terminal 41 in such a way that the difference between Vref0 and Vrefn−1 is smaller when the temperature of the liquid crystal display panel 2 is 60° C. than when the temperature of the liquid crystal display panel 2 is 30° C. That is, the difference between Vref0 and Vrefn−1 which are the outputs from the second voltage control circuit 42c is smaller when the temperature of the liquid crystal display panel 2 is 60° C. than when the temperature of the liquid crystal display panel 2 is 30° C. Thus, the second voltage control circuit 42c changes the difference between Vref0 and Vrefn−1 which are the outputs thereof according to temperature.

Therefore, the source driver drive voltage (AVDD) supplied by the first voltage control circuit 42a is a fixed voltage, invariable with temperature, but the difference between Vref0 and Vrefn−1 supplied by the second voltage control circuit 42c is a voltage which is variable according to temperature, and therefore the voltage is divided through resistors by the circuit made up of n resistors 43a, 43b, . . . , 43n−1 and the source driver drive voltage generation circuit 15 outputs not only the source driver drive voltage (AVDD) but also n voltages Vref0, Vref1, . . . , Vrefn−1 whose voltages are divided through resistors. These output voltages are supplied to the source driver 4 via a flexible printed circuit board (not shown).

The source driver 4 generates voltages corresponding to the respective steps of gradation using AVDD, n voltages Vref0, Vref1, . . . , Vrefn−1.

In this way, the second voltage control circuit 42c of the source driver drive voltage generation circuit 15 shown in FIG. 11 can automatically determine the respective voltages of Vref1, etc., corresponding to the respective steps of gradation by only correcting the difference between Vref0 and Vrefn−1 according to temperature in a well-balanced manner and thereby obtain effects similar to those of the source driver drive voltage generation circuit 15 in FIG. 10.

Furthermore, the source driver drive voltage generation circuit 15 in FIG. 11 corrects both Vref0 and Vrefn−1 according to temperature, and can thereby take a wider dynamic range than that of the source driver drive voltage generation circuit 15 in FIG. 10.

What is claimed is:

1. A liquid crystal display device comprising:
a liquid crystal display panel having source signal lines and gate signal lines arranged in matrix form and liquid crystal display elements, said liquid crystal display elements being provided at intersections between said source signal lines and gate signal lines;
a gate driver that supplies a gate signal to said gate signal lines;
a source driver that supplies a source signal to said source signal lines;
temperature detection means of detecting temperature; and
source driver driving means of supplying a source driver drive voltage according to said detected temperature to said source driver.

2. A liquid crystal display device comprising:
a liquid crystal display panel having source signal lines and gate signal lines arranged in matrix form and liquid crystal display elements, said liquid crystal display elements being provided at intersections between said source signal lines and gate signal lines;
a gate driver that supplies a gate signal to said gate signal lines;
a source driver that supplies a source signal to said source signal lines;
temperature detection means of detecting temperature; and
correcting means of correcting display data for generating said source signal to display data according to said detected temperature,
wherein said source signal is generated based on the corrected display data.

3. The liquid crystal display device according to claim 2, wherein that said correcting means corrects said display data means carrying out gamma correction according to said detected temperature.

4. The liquid crystal display device according to claim 2, wherein that said correcting means corrects said display data means correcting the value of said display data having a value of 0 out of said display data to a first value which is a value according to the detected temperature, and
correcting a second value which is a value of said display data whose signal level is non-zero out of said display data, to a value obtained by adding the first value to a value obtained by subtracting the first value from a third value, which is a maximum value of the value of said display data, then dividing the subtraction result by the third value and multiplying by the second value.

5. The liquid crystal display device according to claim 2, wherein that said correcting means corrects said display data means correcting said display data whose value is a predetermined value or less out of said display data.

6. The liquid crystal display device according to claim 1 or 2, wherein said liquid crystal display element is a liquid crystal display element using OCB mode liquid crystal.

7. A liquid crystal display device driving method of driving a liquid crystal display device, said liquid crystal display device comprising:
a liquid crystal display panel having source signal lines and gate signal lines arranged in matrix form and liquid crystal display elements, said liquid crystal display elements being provided at intersections between said source signal lines and gate signal lines;
a gate driver that supplies a gate signal to said gate signal lines; and
a source driver which supplies a source signal to said source signal line, said method comprising:
a temperature detecting step of detecting temperature; and
a source driver driving step of supplying a source driver drive voltage according to said detected temperature to said source driver.

8. A liquid crystal display device driving method of driving a liquid crystal display device, said liquid crystal display device comprising:
a liquid crystal display panel having source signal lines and gate signal lines arranged in matrix form and liquid crystal display elements, said liquid crystal display elements being provided at intersections between said source signal lines and gate signal lines;
a gate driver that supplies a gate signal to said gate signal lines; and
a source driver which supplies a source signal to said source signal line, said method comprising:
a temperature detecting step of detecting temperature; and
a correcting step of correcting display data for generating said source signal to display data according said detected temperature,
wherein said source signal is generated based on the corrected display data.

9. The liquid crystal display device according to claim 7 or 8, wherein said liquid crystal display element is a liquid crystal display element using OCB mode liquid crystal.
